(19) United States
(12) Patent Application Publication
(10) Pub. No.: US 2025/0006959 A1
(43) Pub. Date: Jan. 2, 2025

(54) MEMBRANE HUMIDIFIER

(71) Applicant: MAHLE International GmbH, Stuttgart (DE)

(72) Inventors: Alexander Jerger, Sachsenheim (DE); Matthias Ortmann, Sindelfingen (DE); Ralf Frommer, Fellbach (DK); Peter Nowak, Stuttgart (DE); Eva Boendel, Stuttgart (DE); Tobias Baumgart

(21) Appl. No.: 18/679,431

(22) Filed: May 30, 2024

(30) Foreign Application Priority Data
May 31, 2023 (DE) 102023205080.3

(51) Int. Cl. H01M 8/04119; H01M 8/248

(52) U.S. Cl. CPC H01M 8/04149; H01M 8/248

(57) ABSTRACT

The invention relates to a membrane humidifier for a fuel cell system with a membrane stack with a plurality of flat membranes and at least one com-pression element made of an elastically deformable material. The compression element can compensate for a temperature-related change in the mem-brane stack. The invention also relates to the membrane stack for the membrane humidifier.

### CROSS-REFERENCE TO RELATED APPLICATIONS

This application claims priority to German Patent Application No. DE 102023205080.3 filed on May 31, 2023, the contents of which are hereby incorporated by reference in its entirety.

### TECHNICAL FIELD

The invention relates to a membrane humidifier for a fuel cell system with a mem-brane stack having a plurality of flat membranes according to the preamble of claim 1. The invention also relates to the membrane stack for the membrane humidifier.

### BACKGROUND

A membrane humidifier typically comprises a membrane stack consisting of a plurality of membranes and a support cage that accommodates the membrane stack. The membranes of the membrane stack are stacked at a distance from one another in a stacking direction such that channels that accommodate a flow can be formed between the membranes transverse to the stacking direction. The membranes are glued together such that the channels in the membrane stack form a cross flow for humid exhaust air flowing from the fuel cell system and dry supply air flowing to the fuel cell system. In total, the membrane stack comprises four side faces that accommodate a flow that are aligned parallel to the stacking direction and two end faces that are aligned transversely to the stacking direction and that do not accommodate a flow. The membrane stack is accommodated in the support cage such that the side faces that accommodate a flow continue to accommodate a flow through the support cage. Due to the dynamic and thermal load, a force acting on the membranes and on the adhesive bond of the membranes arises within the membrane stack. Therefore, the adhesive bond of the membranes must be sufficiently elastic while nevertheless ensuring that the supply air is sufficiently sealed against the exhaust air. At the same time, the membranes in the membrane stack must be rigid enough to minimize the mechanical stress on the adhesive bond.

The object of the invention is therefore to provide an improved or at least alternative embodiment for a membrane humidifier of the generic type that overcomes the described disadvantages. The object of the invention is also to provide a corresponding membrane stack for the membrane humidifier.

According to the invention, this problem is solved by the scope of the independent claims. Advantageous embodiments are the scope of the dependent claims.

The present invention is based on the general idea of compensating the force acting on the membranes and on the adhesive bond of the membranes with a compressible element.

The inventive membrane humidifier is provided or adapted for a fuel cell system. The membrane humidifier comprises a membrane stack with a plurality of flat membranes, wherein the membranes of the membrane stack are stacked at a distance from each other in a stacking direction. As a result, the membrane stack comprises four side faces aligned parallel to the stacking direction and that accommodate a flow, and two end faces aligned transversely to the stacking direction and that do not accommodate a flow. The membrane humidifier also has a support cage. The membrane stack is accommodated in the support cage, wherein the side faces that accommodate a flow can accommodate a flow through the support cage. According to the invention, the membrane stack comprises at least one com-pression element made of an elastically deformable material. The material can in particular be an elastically deformable polymer, in particular an elastically deformable foam. The respective compression element is stacked in the membrane stack with the membranes. A temperature-related change in the length of the membrane stack defined in the stacking direction within the support cage can be compensated by the respective compression element.

The membranes of the membrane stack are stacked at a distance from each other in the membrane stack such that channels that accommodate a flow can be formed between the membranes transverse to the stacking direction. One spacer each that accommodates a flow can be arranged between and/or on the individual adjacent membranes. In particular the distance between the individual adjacent membranes can be maintained by the spacer. Preferably, the membranes are rectangular and identically shaped in relation to one another. The individual membranes can be glued together such that the individual channels in the membrane stack form a cross flow for humid exhaust air flowing from the fuel cell system and dry supply air flowing to the fuel cell system. In other words, the individual membranes can be glued together such that only the opposing side faces of the membrane stack are fluidically connected to one another to accommodate an air flow and/or a fluid flow. The individual membranes are impermeable to air and permeable to steam such that the supply air and the exhaust air can flow through the membrane stack in a cross flow without mixing and can exchange moisture with each other through the individual membranes. The dry supply air flowing to the fuel cell system can absorb moisture from the humid exhaust air flowing from the fuel cell system.

The membranes of the membrane stack are stacked together in stacking direction such that the membrane stack comprises four side faces aligned parallel to the stacking direction and that accommodate a flow and two end faces aligned transversely to the stacking direction and that do not accommodate a flow. The end faces that do not accommodate a flow can in particular be formed by the respective membranes that are last in stacking direction. Since the membranes themselves are impermeable to air and therefore do not accommodate a flow, the end faces of the membrane stack also do not accommodate a flow.

The membrane stack is accommodated in the support cage such that the side faces that accommodate a flow continue to accommodate a flow through the support cage. The support cage can for example comprise two frames and two end plates that are permanently bonded to one another to form a cuboid structure. The membrane stack can then be accommodated in the support cage in a non-displaceable and rotationally fixed manner or be at least regionally surrounded by the support cage to the outside. The respective frames can circumferentially surround two opposing side faces of the membrane stack that accommodate a flow, and the two end plates can abut the end faces of the membrane stack that do not accommodate a flow. The support cage can stabilize the membrane stack and simplify sealing the membrane stack within a housing of the membrane humidifier. The support cage can for example be formed from plastic. The support cage can be joined to the membrane stack with a substance-to-substance bond, for example by gluing.

The membrane humidifier can have a housing and the support cage with the accommodated membrane stack can be accommodated in the housing. The support cage can be adapted and/or arranged in the housing such that the side faces that accommodate a flow of the membrane stack are sealed airtight against each other in the housing, if necessary by means of further separate seals. The housing can have four ports that accommodate a flow from the outside into an interior space of the housing, wherein the respective port can be mapped to the respective side face of the membrane stack that accommodates a flow. Two ports can then form an inlet and an outlet for the dry supply air flowing to the fuel cell system and two ports can then form an inlet and an outlet for the humid exhaust air flowing from the fuel cell system. In the membrane humidifier, the supply air and the exhaust air can flow exclusively through the membrane stack without mixing and exchange moisture with each other.

The membrane stack and the support cage consist of different materials and have a temperature-related change in the length defined in stacking direction. The respective com-pression element is stacked together with the membranes in the membrane stack and can compensate for the temperature-related change of the membrane stack within the support cage. In particular, a temperature-related change of the length of the membrane stack defined in stacking direction of up to +2% can be compensated by the respective compression element within the support cage. The respective compression element can for example be compressed by 10% to 30% during installation. The respective compression element can then in particular compensate a compression of the membrane stack within the support cage. As a result, the adhesive bond of the membranes can be conserved and the overall service life of the membrane stack can be extended.

The respective compression element is formed from the elastically deformable material, wherein the material can be elastically or softly elastically deformable. The material can in particular be an elastically deformable polymer, in particular an elastically deformable foam. The material of the respective compression element can be closed-celled and/or be formed from an ethylene-propylene-diene rubber. The respective compression element can have a thickness between 1 and 4 mm, as defined in stacking direction. The respective compression element can have a compression, as defined in stacking direction, of 10% to 30% or be compressed in the stacking direction by 10% to 30%. The respective compression element can, for example, have a modulus of elasticity greater than or equal to 1.5 kPa and/or a shore hardness equal to 25±6 Shore. The respective compression element can have a water absorption of less than 5% and/or can be compressed in stacking direction by up to 70%. The respective compression element can, for example, have a compression equal to 25% at a compression stress of 35±15 kPa and/or a compression equal to 50% at a com-pression stress equal to 95±25 kPa. At a temperature of 23° C. and a humidity of 50%, the respective compression element can after 30 minutes have a residual compression deformation of less than or equal to 65% and a residual compression deformation of less than or equal to 20% after 24 hours. At a temperature of 40° C. and a humidity of 50%, the respective compression element can have a residual compression deformation of less than or equal to 85% after 30 minutes and a residual compression deformation of less than or equal to 40% after 24 hours.

The membrane stack can comprise exactly one compression element. Alternatively, the membrane stack can comprise a plurality of, i.e. exactly two or exactly three or exactly four or more, compression elements. The respective compression elements can then be dis-tributed in the membrane stack in the stacking direction or arranged separately from one another by the plurality of membranes. The individual compression elements can have a shape that deviates from one another and/or a surface that deviates from one another as defined transversely to the stacking direction and/or a thickness that deviates from one another as defined in stacking direction and/or a structure that deviates from one another and/or a composition that differs from one another. In addition, the individual compression elements can be formed from a material that differs from one another.

The respective compression element can abut the last membrane of the membrane stack and be arranged between the last membrane of the membrane stack and the support cage. Alternatively, the membranes of the membrane stack can be divided into two groups in stacking direction, and the respective compression element can be arranged between the two groups of the membranes.

In one possible embodiment of the membrane humidifier, the membrane stack can for example comprise exactly two compression elements. The two compression elements can abut the last two membranes in stacking direction and thus be arranged in stacking direction between the support cage and the last membranes. In a possible further embodiment of the membrane humidifier, the membrane stack can have a further compression element in addition to the compression elements described above. The further compression element can be arranged centrally in the membrane stack between the membranes. It goes without saying that further embodiments of the membrane humidifier are also conceivable.

The respective compression element can be joined to the respective adjacent mem-brane with a substance-to-substance bond, preferably by gluing. If the respective compression element is arranged between two adjacent membranes in the membrane stack, the respective compression element can be joined to the two adjacent membranes with a sub-stance-to-substance bond, preferably by gluing. If the respective compression element is arranged on the membrane of the membrane stack last in stacking direction, the respective compression element can only be joined to this membrane with a substance-to-substance bond, preferably by gluing.

The respective compression element can for example be formed by a plate aligned transversely to the stacking direction. The respective plate and the respective membranes of the membrane stack can have an identical shape and surface transverse to the stacking direction. Alternatively, the respective compression element can be formed by four plate-shaped corner elements aligned transversely to the stacking direction. The respective corner elements can be arranged in corner regions of the membrane stack. Since the respective adhesive bond of the respective adjacent membranes meets in the corner regions in stacking direction, the membrane stack is particularly rigid in the corner regions. The respective four corner elements can compensate for the temperature-related change in the length of the membrane stack in the corner areas, thus conserving the adhesive bond of the membrane stack. The respective corner elements can have any shape and can for example be square or rectangular transverse to the stacking direction.

One spacer each that accommodates a flow can be arranged between and/or on the individual adjacent membranes. The respective spacer can in particular maintain the distance between the individual membranes. If the respective compression element is formed by the plate, the plate can replace the spacer between the adjacent membranes. If the respective compression element is formed by the four corner elements, the respective corner elements and the respective spacer can be arranged in a common plane transverse to the stacking direction. The respective corner elements and the respective spacer can together cover the entire surface of the respectively adjacent membranes. The spacer can be cross-shaped, for example transverse to the stacking direction. The respective corner elements can then be rectangular or square transverse to the stacking direction and fill in the cross shape of the spacer to form a rectangle.

The invention also relates to the membrane stack with a plurality of flat membranes for the membrane humidifier described above. As already described above, the membranes of the membrane stack are stacked at a distance from each other in a stacking direction. As a result, the membrane stack comprises four side faces aligned parallel to the stacking direction and that accommodate a flow, and two end faces aligned transversely to the stacking direction and that do not accommodate a flow. The membrane stack comprises at least one compression element made of an elastically deformable material. The material can in particular be an elastically deformable polymer, in particular an elastically deformable foam. The respective compression element is stacked in the membrane stack with the membranes, and a temperature-related change in the length of the membrane stack defined in stacking direction can be compensated by the respective compression element. In order to avoid repetitions, reference is made here to the above explanations.

Other important features and advantages of the invention can be seen from the dependent claims, from the drawings and from the associated description of the figure based on the drawings.

It is understood that the above-mentioned features and those yet to be explained below can be used not only in the combination indicated in each case, but also in other combinations or on their own, without deviating from the scope of the present invention.

Preferred exemplary embodiments of the invention are shown in the drawings by way of example and will be explained in more detail in the following description, wherein identical reference symbols refer to identical or similar or functionally identical elements.

### BRIEF DESCRIPTION OF THE DRAWINGS

The drawings show—schematically in each case—in

FIG. 1 a sectional view of an inventive membrane humidifier according in a first embodiment;

FIG. 2 a sectional view of a membrane stack of the membrane humidifier of FIG. 1;

FIG. 3 an enlarged section of the sectional view of the membrane stack of FIG. 2;

FIG. 4 a further sectional view of the membrane humidifier in the first embodiment;

FIG. 5 a further sectional view of the membrane stack of the membrane humidifier of FIG. 4;

FIG. 6 an enlarged section of the further sectional view of the membrane stack of FIG. 5;

FIGS. 7 to 10 exploded views and views of the membrane humidifier in the first embodiment without a housing;

FIGS. 11 and 12 an exploded view of the membrane stack of the membrane humidifier in the first embodiment and an enlarged detail of the exploded view;

FIG. 13 an exploded view of the membrane stack of the membrane humidifier in the first embodiment;

FIG. 14 an exploded view of the membrane stack of the inventive membrane humidifier in a second embodiment;

FIGS. 15 to 18 plan views of individual layers of the membrane stack of the mem-brane humidifier in the second embodiment.

### DETAILED DESCRIPTION

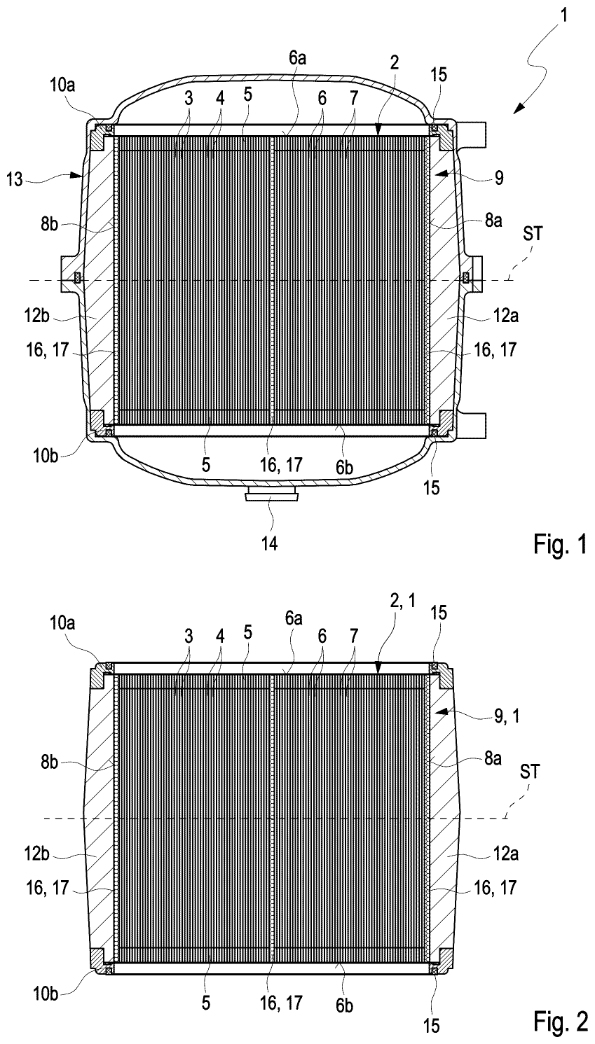

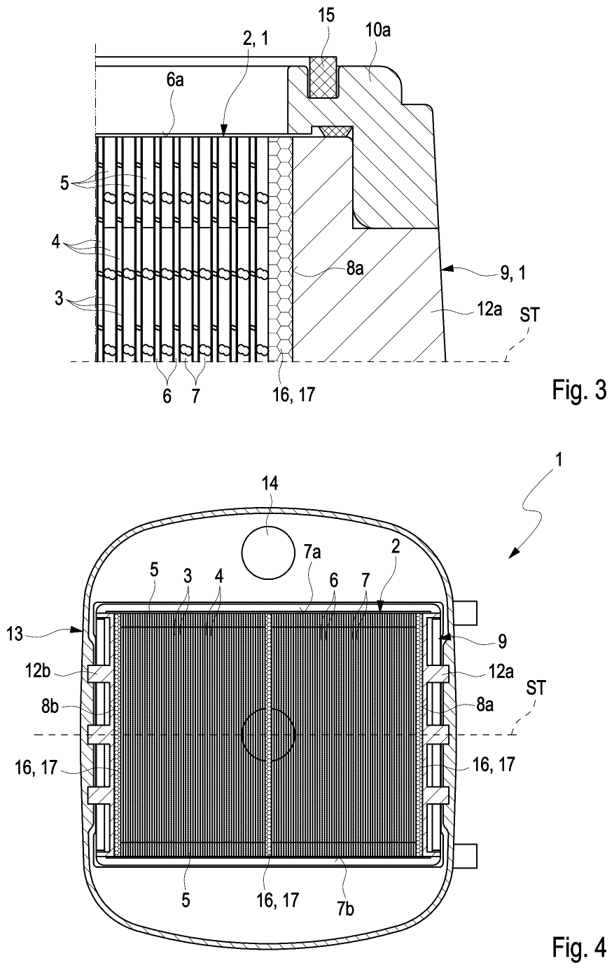

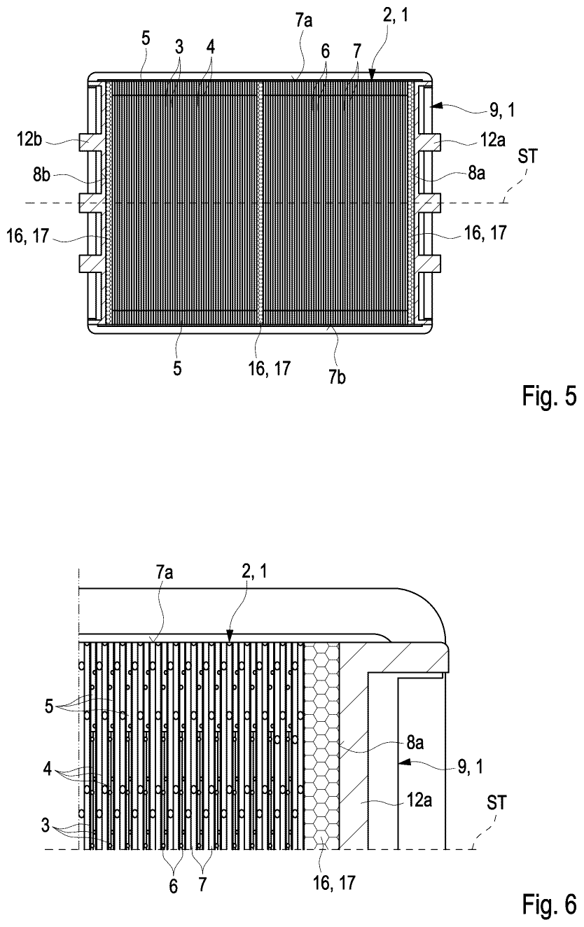

FIG. 1 shows a sectional view of an inventive membrane humidifier 1 for a fuel cell system in a first embodiment with a membrane stack 2. FIG. 2 shows a sectional view of the membrane stack 2 of the membrane humidifier 1 of FIG. 1. FIG. 3 shows an enlarged section of the sectional view of the membrane stack 2 of FIG. 2. FIG. 4 shows a further sectional view of the membrane humidifier 1 in the first embodiment. FIG. 5 shows a further sectional view of the membrane stack 2 of the membrane humidifier 1 of FIG. 4. FIG. 6 shows an enlarged section of the further sectional view of the membrane stack 2 of FIG. 5.

The membrane stack 2 of the membrane humidifier 1 is cuboid and comprises sev-eral flat square membranes. The membranes 3 are stacked at a distance from each other in a stacking direction ST and—as can be seen in particular in FIG. 3 and in FIG. 6—are separated from each other by spacers 4 that accommodate a flow. The individual membranes 3 and the spacers 4 are glued together by means of an adhesive 5, wherein channels 6 and 7 that accommodate a flow are thus formed between the individual membranes 3. The membranes 3 are impermeable to air and permeable to steam.

As a result, the membrane stack 2 comprises four side faces 6a, 6b and 7a, 7b that accommodate a flow and that are aligned parallel to the stacking direction ST, and two end faces 8a, 8b that do not accommodate a flow and that are aligned transversely or perpen-dicular to the stacking direction ST. The channels 6 and 7 that accommodate a flow are alternately in relation to each other arranged in the cross flow in stacking direction ST. The channels 6 fluidically connect the side faces 6a and 6b such that these accommodate a fluid flow or air flow through the membrane stack 2 and are fluidically separated from the side faces 7a and 7b by the adhesive 5. The channels 7 fluidically connect the side faces 7a and 7b such that these accommodate a fluid flow or air flow through the membrane stack 2 and are fluidically separated from the side faces 6a and 6b by the adhesive 5.

The membrane humidifier 1 further comprises a cuboid support cage 9 in which the membrane stack 2 is accommodated. The support cage 9 and the membrane stack 2 are glued together and thus separate the side faces 6a, 6b and 7a, 7b that accommodate a flow against one another in the support cage 9 with a fluid-tight or air-tight seal. The support cage 9 comprises two frames 10a, 10b that are aligned parallel to the stacking direction ST and are mapped to the side faces 6a, 6b that accommodate a flow, and two end plates 12a, 12b that are aligned transversely or perpendicularly to the stacking direction St and are mapped to the two end faces 8a, 8b. The respective frames 10a, 10b surround the respective side faces 6a, 6b along their perimeter, wherein the side faces 6a, 6b and 7a, 7b continue to accommodate a flow through the support cage 9. The end plates 12a, 12b abut the end faces 8a, 8b of the membrane stack 2.

In addition, the membrane humidifier 1 comprises a housing 13 that accommodates the support cage 9 with the membrane stack 2. The housing 13 comprises a total of four ports 14-FIG. 1 to FIG. 6 only show one of the four ports—each of which are mapped to one of the side faces 6a, 6b and 7a, 7b. The support cage 9 is formed and/or accommodated in the housing 13 and sealed with seals 15 such that the respective side faces 6a, 6b and 7a, 7b that accommodate a flow, as well as the individual ports 14, are separated from one another with a fluid-tight and/or air-tight seal.

In the membrane humidifier 1, for example, a dry supply air flowing to the fuel cell system can be humidified with humid exhaust air flowing from the fuel cell system. The humid exhaust air can be guided via the respectively one port 14 into the housing 13 to the side face 6a; can be guided through the channels 6 of the membrane stack 2; and can be guided by the side face 6b out of the housing 13 via the respectively other port 14. The humid supply air can be guided via the respectively one port 14 into the housing 13 to the side face 7a; can be guided through the channels 7 of the membrane stack 2; and can be guided by the side face 7b out of the housing 13 via the respectively other port 14. The humid exhaust air and the dry supply air flow through the membrane humidifier 1 without mixing, wherein the dry supply air is humidified with the humid exhaust air through the air-impermeable and steam-permeable membranes 3 when the channels 6 and 7 accommodate a flow.

The membrane stack 2 also comprises exactly three compression elements 16 made of an elastically deformable material, here made of a foam. The foam can in particular be closed-celled and soft-elastic. The closed-celled structure of the foam ensures reduced water absorption and the soft-elastic structure of the foam ensures a high degree of compressibility of the respective compression elements 16. Due to their high compressibility, the respective compression elements 16 can absorb a temperature-related change of the mem-brane stack 2 in the stacking direction ST such that the membrane stack 2 remains securely glued to the support cage 9 regardless of the temperature-related change of the membrane stack 2. The respective compression elements 16 are glued to the respectively adjacent membranes 3.

In the first embodiment of the membrane humidifier 1, the compression elements 16 are formed by plates 17. The respective plates 17 are aligned transversely to the stacking direction ST and are identical in shape and surface to the membranes 3 of the membrane stack 2. Two of the three plates 17 positioned against the membranes 3 last in stacking direction ST of the membrane stack 2. The two longitudinally end-facing plates 17 form the end faces 8a, 8b of the membrane stack 2 and are positioned between the end plates 12a, 12b of the support cage 9 and the respectively last membranes 3 of the membrane stack 2. The respectively longitudinally end-facing compression elements 16 can be glued to the end plates 12a, 12b. One of the three plates 17 is arranged centrally in the membrane stack 2 between two adjacent membranes 3 and can replace the spacer 4 between the respective membranes 3.

FIG. 1 to FIG. 3 show a cross-section of the membrane humidifier 1 and the mem-brane stack 2 in a plane aligned parallel to the side faces 7a, 7b. FIG. 4 to FIG. 6 show a cross-section of the membrane humidifier 1 and the membrane stack 2 in a plane aligned parallel to the side faces 6a, 6b.

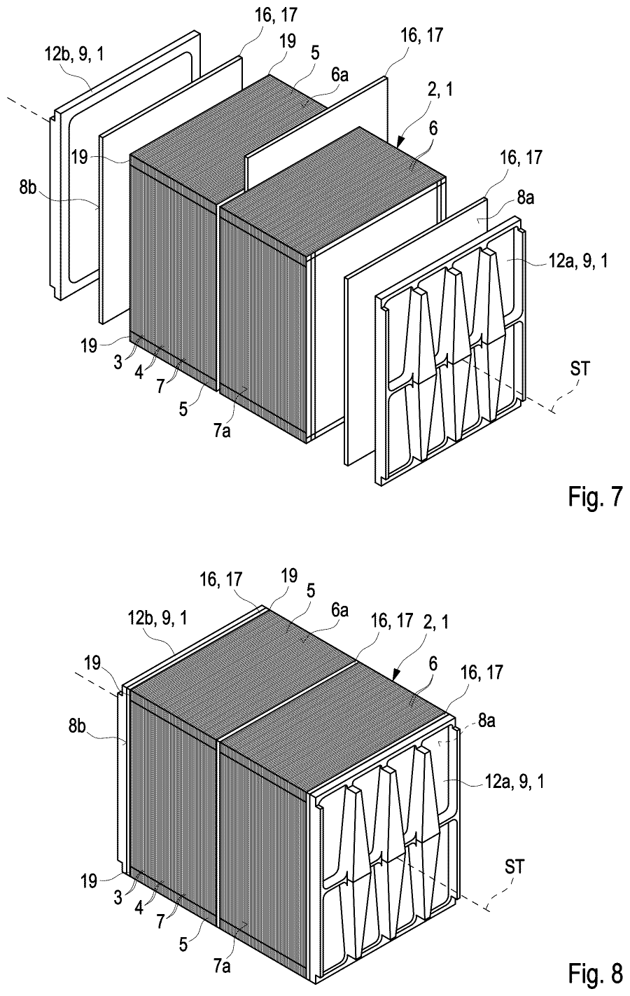

FIG. 7 shows an exploded view and FIG. 8 shows a view of the membrane stack 2 and the support cage 9. The compression elements 16—in this case the plates 17—are arranged centrally and longitudinally end-facing in the membrane stack 2. In addition, the two end plates 12a, 12b of the support cage 9 are shown, which abut the end faces 8a, 8b of the membrane stack 2-here on the respective plates 17.

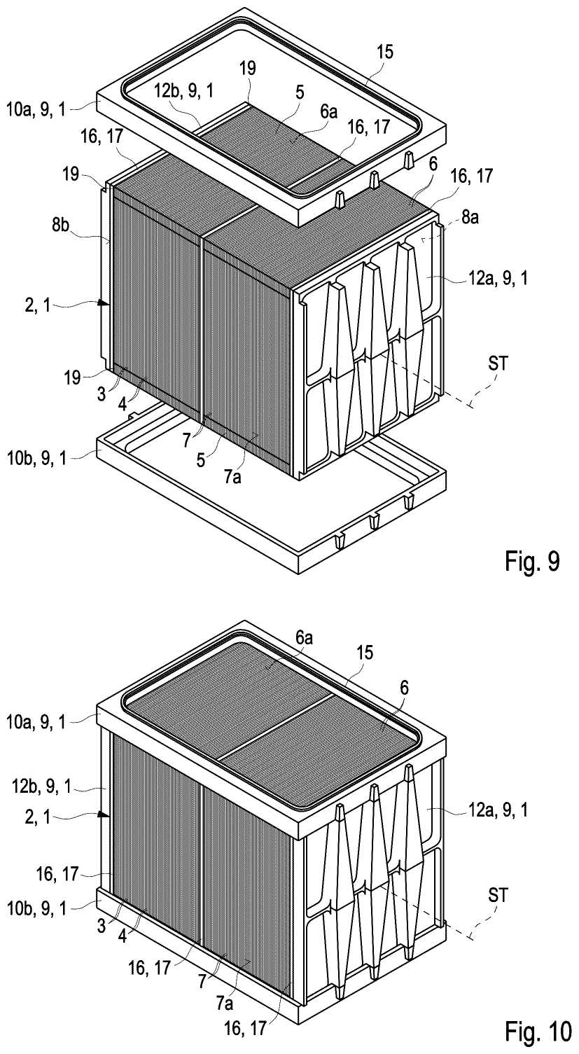

FIG. 9 shows an exploded view and FIG. 10 shows a view of the membrane stack 2 and the support cage 9. Here, the two frames 10a and 10b of the support cage 9 are shown with circumferential seals 15 that are arranged on the side faces 6a, 6b of the membrane stack 2. The frames 10a and 10b surround the two side faces 6a and 6b on their perimeter and can be glued to the membrane stack 2.

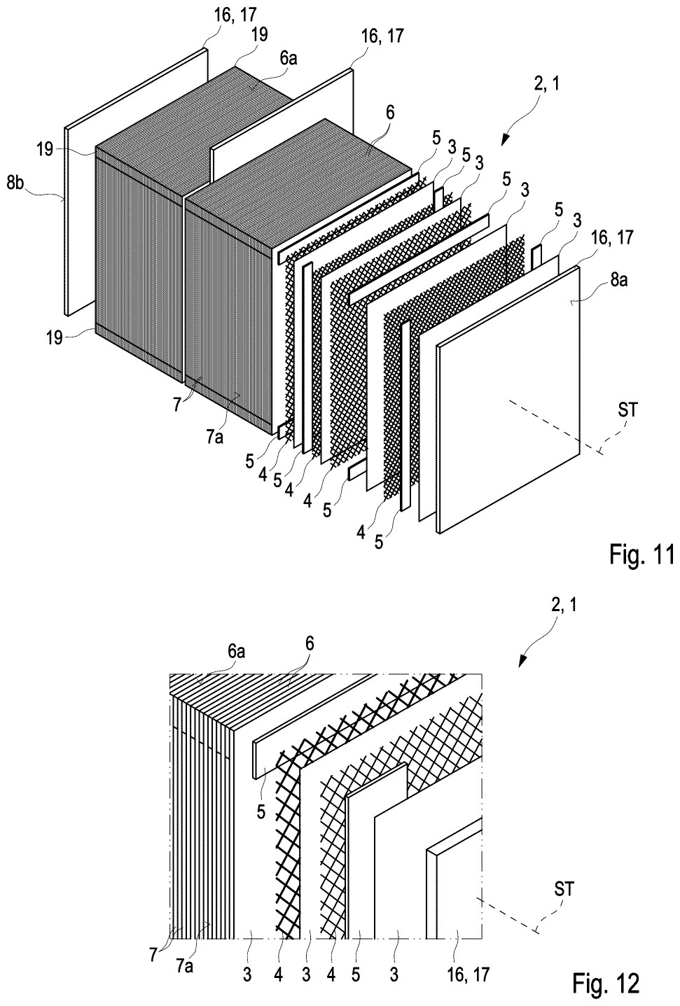

FIG. 11 shows an exploded view of the membrane stack 2 and FIG. 12 shows an enlarged section of the exploded view of FIG. 11. FIG. 11 and FIG. 12 in particular show the alternating adhesive bond of the membranes 3 by means of the adhesive 5, thus forming the channels 6 and 7 in the membrane stack 2. As can also be seen here, the spacers 4 are arranged, and also glued, between the individual membranes 3.

FIG. 13 shows an exploded view of the membrane stack 2 of the membrane humidifier 1 in the first embodiment. Here, in particular the layer formation in the membrane stack 2 is discernible.

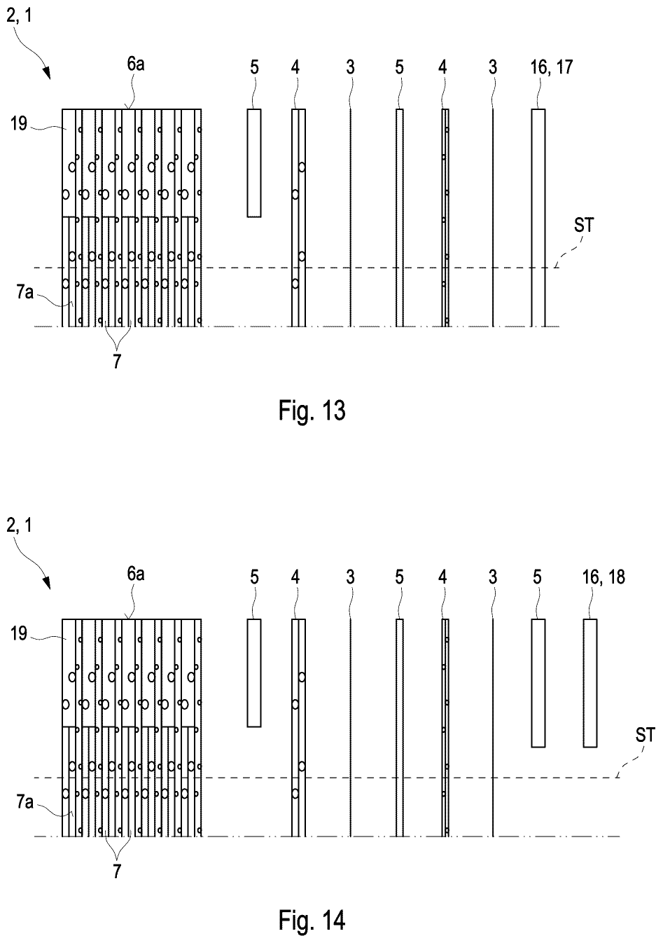

FIG. 14 shows an exploded view of the membrane stack 2 of the inventive membrane humidifier 1 in a second embodiment. In contrast to the first embodiment in FIG. 1-13, the compression elements 16 of the membrane stack 2 are formed differently here. Here, the respective compression element 16 is formed by four rectangular plate-shaped corner elements 18 that are arranged in corner regions 19 of the respective membranes 3 and are glued to the membranes 3. FIG. 14 shows only one of the four corner elements 18 of the longitudinally end-facing compression element 16. The first and second embodiment of the mem-brane humidifier 1 match in all other respects.

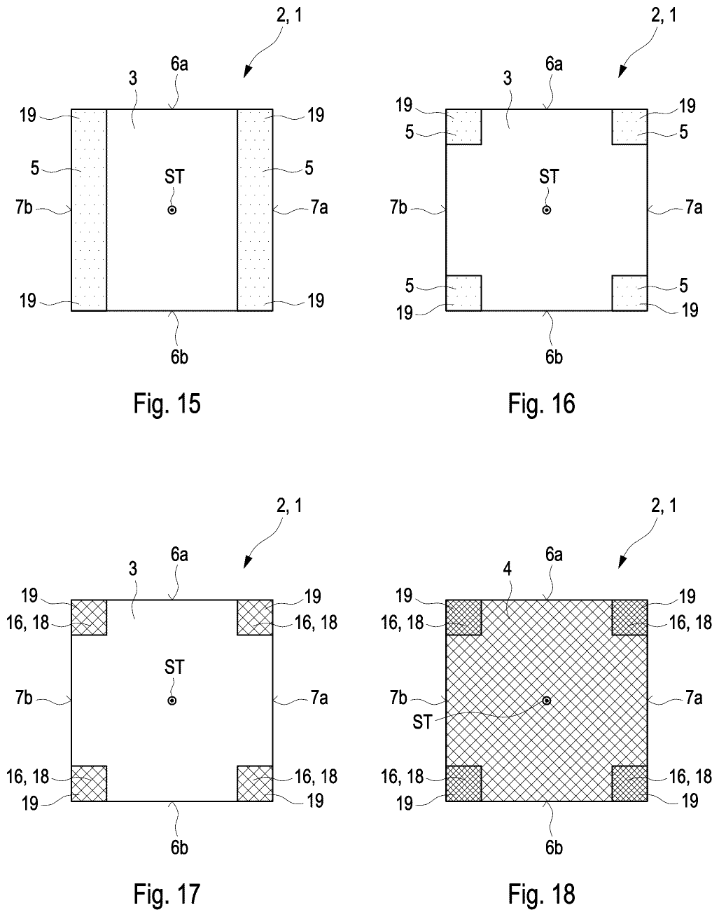

FIG. 15 to FIG. 18 show plan views of individual layers of the membrane stack 2 of the membrane humidifier 1 in the second embodiment. In FIG. 15 to FIG. 18, the membrane stack 2 is incrementally constructed from the drawing plane and the compression element 16 arranged centrally in the membrane stack 2 is integrated into the membrane stack 2.

FIG. 15 shows a plan view onto the membrane 3 located centrally in the membrane stack 2, and onto which the adhesive 5 is applied to form the channel 6. FIG. 16 shows a plan view of the membrane 3 closest to the stacking direction ST, and which is glued to the membrane 3 of FIG. 15. Adhesive 5 is applied to the membrane 3 in the corner regions 19 of the membrane stack 2. FIG. 17 shows a plan view onto the membrane 3 of FIG. 16, wherein the corner elements 18 of the compression element 16 arranged centrally in the membrane stack 2 are arranged here in the corner regions 19. The corner elements 18 are glued to the membrane 3 with the adhesive 5. FIG. 18 shows a plan view onto the membrane 3 of FIG. 17, wherein the spacer element 4 with cross-shaped cut-outs is arranged here on the membrane 3. The cross-shaped spacer element 4 and the four corner elements 18 form a common surface that is identical to the surface of the membrane 3. Adhesive 5 can now be applied to the corner elements 18 and the next membrane 3 can be glued to the corner elements 18. The membrane stack 2 can then be formed further.

1. A membrane humidifier for a fuel cell system, comprising:
a membrane stack with a plurality of flat membranes,
wherein the membranes of the membrane stack are stacked at a distance from one another in a stacking direction (ST), and
wherein the membrane stack includes four side faces that accommodate a flow and that are oriented parallel to the stacking direction (ST) and two end faces that do not accommodate a flow and that are oriented transversely to the stacking direction (ST);
wherein the membrane humidifier comprises a support cage, and the membrane stack is accommodated in the support cage, and
the side faces accommodate a flow through the support cage; and wherein
the membrane stack includes at least one compression element made of an elastically deformable material and the respective compression element is stacked in the membrane stack with the membranes; and in that
a temperature-related change in the length of the membrane stack defined in stacking direction (ST) can be compensated by the respective compression element within the support cage.

2. The membrane humidifier according to claim 1, wherein the temperature-related change of the length of the membrane stack defined in stacking direction (ST) of up to ±2% can be compensated by the respective compression element within the support cage.

3. The membrane humidifier according to claim 1, and including at least one of the following:
the material of the respective compression element is soft-elastically deformable;
the material of the respective compression element is closed-celled;
the material of the respective compression element is formed from an ethylene propylene diene rubber;, and/or in that
the respective compression element includes a modulus of elasticity greater than or equal to 1.5 kPa;, and/or in that
the respective compression element has a Shore hardness equal to 25±6 Shore;
the respective compression element has a thickness between 1 and 4 mm defined in stacking direction (ST);, and/or in that
the respective compression element has a compression defined in stacking direction (ST) of 10% to 30%;, and/or in that
the respective compression element can be compressed in stacking direction (ST) by up to 70%;; and/or in that
the respective compression element has a water absorption of less than 5%;
the respective compression element has a compression equal to 25% at a compression stress of 35±15 kPa and/or a compression equal to 50% at a compression stress of 95±25 kPa; and, and/or in that
the respective compression element has a residual compression deformation of less than or equal to 65% at a temperature of 23° C. and a humidity of 50% after 30 minutes and a residual compression deformation of less than or equal to 20% after 24 hours and/or a residual compression deformation of less than or equal to 85% at a temperature of 40° C. and a humidity of 50% after 30 minutes, and a residual compression deformation of less than or equal to 40% after 24 hours.

4. The membrane humidifier according to claim 1 any of the above claims,
wherein
the respective compression element abuts the last membrane of the membrane stack and is arranged between the last membrane of the mem brane stack and the support cage.

5. The membrane humidifier according claim 1,
wherein
the membranes of the membrane stack are divided into two groups in stacking direction (ST) and in that the respective compression element is arranged between the two groups of the membranes.

6. The membrane humidifier according to claim 1,
wherein
the respective compression element is joined to the respective adjacent membrane with a substance-to-substance bond, preferably by gluing.

7. The membrane humidifier according to claim 1,
wherein
the respective compression element is formed by a plate aligned transverse to the stacking direction (ST), wherein the respective plate and the respective membranes of the membrane stack have an identical shape and surface transverse to the stacking direction (ST).

8. The membrane humidifier according to claim 1,
wherein
the respective compression element is formed by four plate-shaped corner elements aligned transversely to the stacking direction (ST), wherein the respective corner elements are arranged in corner regions of the mem brane stack.

9. The membrane humidifier according to claim 8,
wherein
one spacer each that accommodates a flow is arranged between and/or on the individual adjacent membranes;
the respective corner elements and the respective spacer are arranged in a common plane transverse to the stacking direction (ST);
the respective corner elements and the respective spacer together cover the entire surface of the respective adjacent membrane.

10. A membrane stack, comprising: with
a plurality of flat membranes for a membrane humidifier,
wherein the membranes of the membrane stack are stacked at a distance from one another in a stacking direction (ST):
four side faces that accommodate a flow and that are oriented parallel to the stacking direction (ST) and two end faces that do not accommodate a flow and that are oriented transversely to the stacking direction (ST);
at least one compression element made of an elastically deformable material and the respective compression element is stacked in the membrane stack with the membranes; and
a temperature-related change in the length of the membrane stack defined in the stacking direction (ST) can be compensated by the respective compression element.

11. The membrane stack according to claim 10, wherein the temperature-related change of the length of the membrane stack defined in stacking direction (ST) of up to ±2% can be compensated by the respective compression element within a support cage.

12. The membrane stack according to claim 10, and including at least one of the following:
the material of the respective compression element is soft-elastically deformable;
the material of the respective compression element is closed-celled;
the material of the respective compression element is formed from an ethylene propylene diene rubber;
the respective compression element includes a modulus of elasticity greater than or equal to 1.5 kPa;
the respective compression element has a Shore hardness equal to 25±6 Shore;
the respective compression element has a thickness between 1 and 4 mm defined in stacking direction (ST);
the respective compression element has a compression defined in stacking direction (ST) of 10% to 30%;
the respective compression element can be compressed in stacking direction (ST) by up to 70%;
the respective compression element has a water absorption of less than 5%;
the respective compression element has a compression equal to 25% at a compression stress of 35±15 kPa and/or a compression equal to 50% at a compression stress of 95±25 kPa; and
the respective compression element has a residual compression deformation of less than or equal to 65% at a temperature of 23° C. and a humidity of 50% after 30 minutes and a residual compression deformation of less than or equal to 20% after 24 hours and/or a residual compression deformation of less than or equal to 85% at a temperature of 40° C. and a humidity of 50% after 30 minutes, and a residual compression deformation of less than or equal to 40% after 24 hours.

13. The membrane stack according to claim 10, wherein
the material of the respective compression element is soft-elastically deformable;
the material of the respective compression element is closed-celled;
the material of the respective compression element is formed from an ethylene propylene diene rubber;
the respective compression element includes a modulus of elasticity greater than or equal to 1.5 kPa;
the respective compression element has a Shore hardness equal to 25±6 Shore;
the respective compression element has a thickness between 1 and 4 mm defined in stacking direction (ST);
the respective compression element has a compression defined in stacking direction (ST) of 10% to 30%;
the respective compression element can be compressed in stacking direction (ST) by up to 70%;
the respective compression element has a water absorption of less than 5%;
the respective compression element has a compression equal to 25% at a compression stress of 35±15 kPa and/or a compression equal to 50% at a compression stress of 95±25 kPa; and
the respective compression element has a residual compression deformation of less than or equal to 65% at a temperature of 23° C. and a humidity of 50% after 30 minutes and a residual compression deformation of less than or equal to 20% after 24 hours and/or a residual compression deformation of less than or equal to 85% at a temperature of 40° C. and a humidity of 50% after 30 minutes, and a residual compression deformation of less than or equal to 40% after 24 hours.

14. The membrane stack according to claim 11, wherein the respective compression element abuts the last membrane and is arranged between the last membrane and the support cage.

15. The membrane stack according to claim 10, wherein the membranes are divided into two groups in stacking direction (ST) and in that the respective compression element is arranged between the two groups of the membranes.

16. The membrane stack according to claim 10, wherein the respective compression element is joined to the respective adjacent membrane with a substance-to-substance bond.

17. The membrane stack according to claim 10, wherein the respective compression element is formed by a plate aligned transverse to the stacking direction (ST), wherein the respective plate and the respective membranes have an identical shape and surface transverse to the stacking direction (ST).

18. The membrane stack according to claim 10, wherein the respective compression element is formed by four plate-shaped corner elements aligned transversely to the stacking direction (ST), wherein the respective corner elements are arranged in corner regions.

19. The membrane stack according to claim 18, wherein one spacer each that accommodates a flow is arranged between and/or on the individual adjacent membranes;
the respective corner elements and the respective spacer are arranged in a common plane transverse to the stacking direction (ST); and
the respective corner elements and the respective spacer together cover the entire surface of the respective adjacent membrane.

20. The membrane humidifier according to claim 1, wherein
the material of the respective compression element is soft-elastically deformable;
the material of the respective compression element is closed-celled;
the material of the respective compression element is formed from an ethylene propylene diene rubber;
the respective compression element includes a modulus of elasticity greater than or equal to 1.5 kPa;
the respective compression element has a Shore hardness equal to 25±6 Shore;
the respective compression element has a thickness between 1 and 4 mm defined in stacking direction (ST);
the respective compression element has a compression defined in stacking direction (ST) of 10% to 30%;
the respective compression element can be compressed in stacking direction (ST) by up to 70%;
the respective compression element has a water absorption of less than 5%;
the respective compression element has a compression equal to 25% at a compression stress of 35±15 kPa and/or a compression equal to 50% at a compression stress of 95±25 kPa; and
the respective compression element has a residual compression deformation of less than or equal to 65% at a temperature of 23° C. and a humidity of 50% after 30 minutes and a residual compression deformation of less than or equal to 20% after 24 hours and/or a residual compression deformation of less than or equal to 85% at a temperature of 40° C. and a humidity of 50% after 30 minutes, and a residual compression deformation of less than or equal to 40% after 24 hours.
